(19) United States
(12) Patent Application Publication
(10) Pub. No.: US 2024/0059816 A1
(43) Pub. Date: Feb. 22, 2024

(54) OLEFIN-BASED POLYMER AND METHOD FOR PREPARING THE SAME

(71) Applicant: HANWHA SOLUTIONS CORPORATION, Seoul (KR)

(72) Inventors: Sung Dong KIM, Daejeon (KR); Munhee LEE, Daejeon (KR); Ui Gap JOUNG, Daejeon (KR); Jeong Hyun PARK, Daejeon (KR); Junho SEO, Daejeon (KR); Seongjeon LIM, Daejeon (KR); Hye Ran PARK, Daejeon (KR); Jisong JO, Daejeon (KR)

(73) Assignee: HANWHA SOLUTIONS CORPORATION, Seoul (KR)

(21) Appl. No.: 18/267,722

(22) PCT Filed: Dec. 10, 2021
(86) PCT No.: PCT/KR2021/018730

§ 371 Date: Jun. 15, 2023

(30) Foreign Application Priority Data
Dec. 17, 2020 (KR) 10-2020-0177033

(51) Int. Cl. C08F 210/16; C08F 2/34; C08F 4/659; C08F 4/6592; C08L 23/08

(52) U.S. Cl. CPC C08F 210/16; C08F 2/34; C08F 4/65912; C08F 4/65916; C08F 4/65925; C08L 23/0815; C08L 2203/162; C08L 2207/066

(57) ABSTRACT

An olefin-based polymer and a method for preparing the olefin-based polymer are disclosed. The olefin-based polymer has excellent heat-sealing property due to the high proportion of a copolymer, which has many branches and is derived from comonomers. The olefin-based polymer has a density of 0.915 to 0.950 g/cm³, a melt index (I_{2.16}) of 0.5 to 1.5 g/10 min as measured with a load of 2.16 kg at 190° C., and a polydispersity index (Mw/Mn) of 2 to 6.

### DESCRIPTION

### Technical Field

The present invention relates to an olefin-based polymer and a method for preparing the same. Specifically, the present invention relates to an olefin-based polymer having excellent heat-sealing property and a method for preparing the same.

### Background Art

A metallocene catalyst which is one of the catalysts used in olefin polymerization, which is a compound in which a ligand such as cyclopentadienyl, indenyl, or cycloheptadienyl is coordinated to a transition metal or a transition metal halogen compound, has a sandwich structure as a basic form.

A Ziegler-Natta catalyst which is another catalyst used for polymerizing olefins has heterogeneous properties of an active site, since a metal component as an active site is dispersed on an inert solid surface; however, the metallocene catalyst is known as a single-site catalyst having identical polymerization properties in all active sites, since it is one compound having a certain structure. A polymer polymerized with the metallocene catalyst as such has a narrow molecular weight distribution, a uniform comonomer distribution, and copolymerization activity higher than the Ziegler Natta catalyst.

Meanwhile, a linear low-density polyethylene (LLDPE) is prepared by copolymerizing ethylene and a-olefin at a low pressure using a polymerization catalyst, has a narrow molecular weight distribution and a short chain branch (SCB) having a certain length, and does not have a long chain branch (LCB) in general. A film prepared with a linear low-density polyethylene has high breaking strength and elongation, and excellent tear strength, impact strength, and the like, together with general properties of polyethylene, and thus, is widely used in a stretch film, an overlap film, and the like to which it is conventionally difficult to apply low-density polyethylene or high-density polyethylene.

However, the linear low-density polyethylene prepared by a metallocene catalyst has poor processability due to a narrow molecular weight distribution, and a film prepared therefrom tends to have lowered heat seal properties.

Therefore, an olefin-based polymer having excellent heat-sealing property is being demanded.

### DISCLOSURE

### Technical Problem

An object of the present invention is to provide an olefin-based polymer having excellent heat-sealing property.

Another object of the present invention is to provide a method for preparing the olefin-based polymer.

### Technical Solution

In one general aspect, an olefin-based polymer which has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 6; and (4) satisfies the following Relation 1 in temperature rising elution fractionation (TREF) of a multimodal distribution is provided:

C₆₅-C₄₅>15 (%) [Relation 1]
wherein C₄₅ is a weight % of a polymer eluted at 45° C., and C₆₅ is a weight % of a polymer eluted at 65° C.

In a specific example of the present invention, the olefin-based polymer may be prepared by polymerizing an olefin-based monomer in the presence of a hybrid catalyst including: at least one first transition metal compound represented by the following Chemical Formula 1; and at least one second transition metal compound selected from a compound represented by the following Chemical Formula 2 and a compound represented by the following Chemical Formula 3:

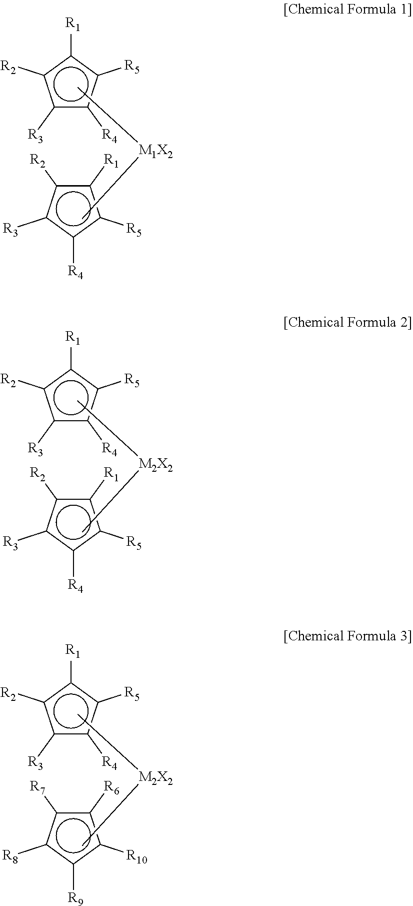

wherein M₁ and M₂ are different from each other and independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, and

R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of each other connected to an adjacent group to form a substituted or unsubstituted and saturated or unsaturated C₄₋₂₀ ring.

In a specific example of the present invention, M₁ and M₂ may be different from each other and zirconium or hafnium, respectively, X may be halogen or C₁₋₂₀ alkyl, and R₁ to R₁₀ may be independently of each other hydrogen, substituted or unsubstituted C₁₋₂₀ alkyl, substituted or unsubstituted C₁₋₂₀ alkenyl, or substituted or unsubstituted C₆₋₂₀ aryl.

In a preferred specific example of the present invention, M₁ may be hafnium, M₂ may be zirconium, and X may be chlorine or methyl.

In a preferred specific example of the present invention, the first transition metal compound may be at least one of transition metal compounds represented by the following Chemical Formulae 1-1 and 1-2, and the second transition metal compound may be at least one of transition metal compounds represented by the following Chemical Formulae 2-1, 2-2, and 3-1:

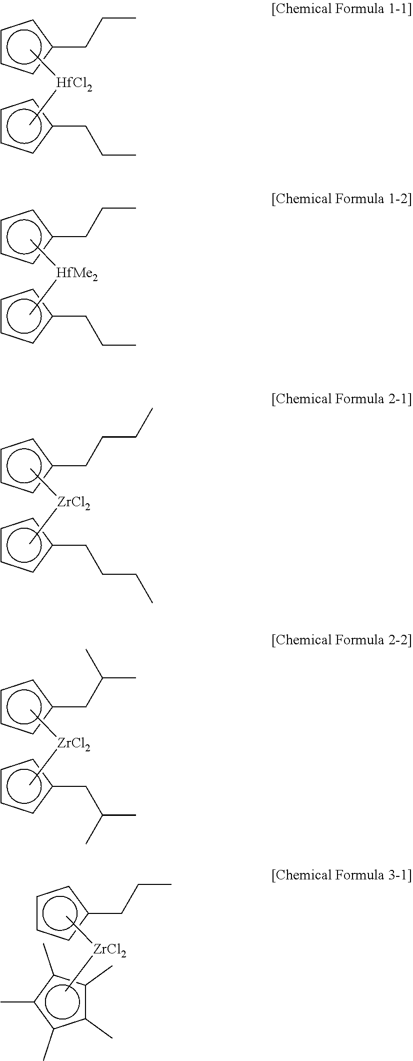

wherein Me is a methyl group.

In a specific example of the present invention, a mole ratio of the first transition metal compound to the second transition metal compound is in a range of 100:1 to 1:100.

In a specific example of the present invention, the catalyst may include at least one cocatalyst selected from the group consisting of a compound represented by the following Chemical Formula 4, a compound represented by the following Chemical Formula 5, and a compound represented by the following Chemical Formula 6:

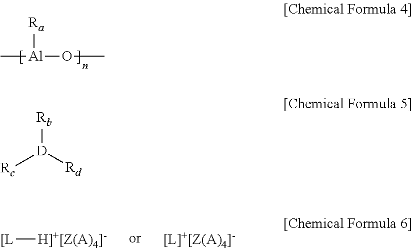

wherein n is an integer of 2 or more, R a is a halogen atom, a C₁₋₂₀ hydrocarbon group, or a C₁₋₂₀ hydrocarbon group substituted with halogen,
D is aluminum (Al) or boron (B) , R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

In a specific example of the present invention, the catalyst may further include a carrier which supports a transition metal compound, a cocatalyst compound, or both of them.

In a preferred specific example of the present invention, the carrier may include at least one selected from the group consisting of silica, alumina, and magnesia.

Herein, a total amount of the hybrid transition metal compound supported on the carrier may be 0.001 to 1 mmol based on 1 g of the carrier, and a total amount of the cocatalyst compound supported on the carrier may be 2 to 15 mmol based on 1 g of the carrier.

In a specific example of the present invention, the olefin-based polymer may be a copolymer of an olefin-based monomer and an olefin-based comonomer. Specifically, the olefin-based monomer may be ethylene, and the olefin-based comonomer may be at least one selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene. Preferably, the olefin-based polymer may be a linear low-density polyethylene in which the olefin-based polymer is ethylene and the olefin-based monomer is 1-hexene.

In another general aspect, a method for preparing an olefin-based polymer includes: polymerizing an olefin-based monomer in the presence of a hybrid catalyst including: at least one first transition metal compound represented by Chemical Formula 1; and at least one second transition metal compound selected from a compound represented by Chemical Formula 2 and a compound represented by Chemical Formula 3, thereby obtaining an olefin-based polymer, wherein the olefin-based polymer has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 6; and (4) satisfies the following Relation 1 in temperature rising elution fractionation (TREF) of a multimodal distribution:

C₆₅-C₄₅>15 (%) [Relation 1]
wherein C₄₅ is a weight % of a polymer eluted at 45° C., and C₆₅ is a weight % of a polymer eluted at 65° C.

In a specific example of the present invention, polymerization of the olefin-based monomer may be performed by gas phase polymerization, and specifically, the polymerization of the olefin-based monomer may be performed in a gas phase fluidized bed reactor.

### Advantageous Effects

The olefin-based polymer according to an exemplary embodiment of the present invention has a high proportion of a highly branched copolymer derived from a comonomer, and thus, has excellent heat-sealing property.

### DESCRIPTION OF DRAWINGS

FIG. 1 is a temperature rising elution fractionation (TREF) graph for describing Relation 1.

FIGS. 2 to 4 are temperature rising elution fractionation (TREF) graphs of olefin-based polymers of Examples 1 to 3, respectively.

FIGS. 5 and 6 are temperature rising elution fractionation (TREF) graphs of olefin-based polymers of Comparative Examples 1 and 2, respectively.

### Best Mode

Hereinafter, the present invention will be described in more detail.

### Olefin-Based Polymer

According to an exemplary embodiment of the present invention, an olefin-based polymer which has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 6; and (4) satisfies the following Relation 1 in temperature rising elution fractionation (TREF) of a multimodal distribution is provided:

C₆₅-C₄₅>15 (%) [Relation 1]
wherein C₄₅ is a weight % of a polymer eluted at 45° C., and C₆₅ is a weight % of a polymer eluted at 65° C.

In a specific example of the present invention, the olefin-based polymer has the density of 0.915 to 0.950 g/cm³. Preferably, the olefin-based polymer may have the density of 0.915 to 0.940 g/cm³.

In a specific example of the present invention, the olefin-based polymer may have the melt index (I_{2.16}) of 0.5 to 1.5 g/10 min as measured with a load of 2.16 kg at 190° C. Preferably, the olefin-based polymer may have the melt index of 0.6 to 1.2 g/10 min as measured with a load of 2.16 kg at 190° C.

In a specific example of the present invention, the olefin-based polymer may have the polydispersity index (Mw/Mn) of 2 to 6. Preferably, the olefin-based polymer may have the polydispersity index of 4 to 6.

In a specific example of the present invention, the olefin-based polymer may have a value of C₆₅-C₄₅ of Relation 1 of more than 15 (%) in the temperature rising elution fractionation of a multimodal distribution.

In the TREF curve of the multimodal distribution, an area of a TREF peak positioned between 45 and 65° C. refers to an amount of a highly branched copolymer derived from a comonomer, and as the proportion is high, a polymer having high heat-sealing property may be obtained.

The olefin-based polymer according to an exemplary embodiment of the present invention is prepared by polymerizing an olefin-based monomer in the presence of a hybrid catalyst including: at least one first transition metal compound represented by the following Chemical Formula 1; and at least one second transition metal compound selected from a compound represented by the following Chemical Formula 2 and a compound represented by the following Chemical Formula 3:

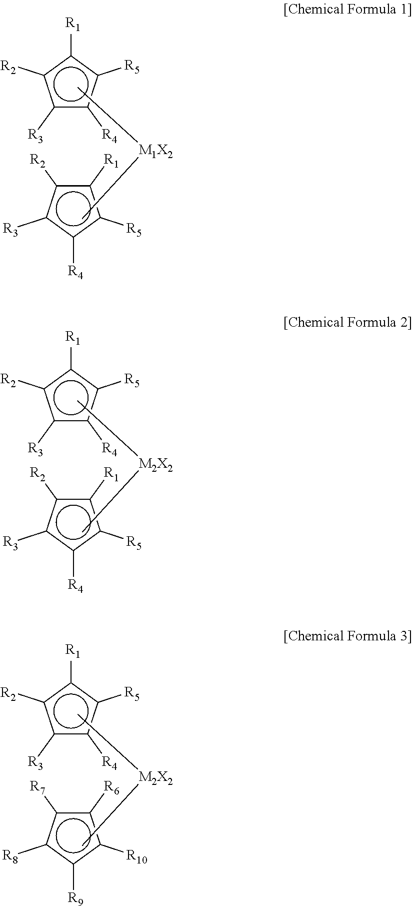

wherein M₁ and M₂ are different from each other and independently of each other titanium (Ti), zirconium (Zr), or hafnium (Hf), specifically, M₁ and M₂ may be different from each other and zirconium or hafnium, respectively, and preferably, M₁ may be hafnium and M₂ may be zirconium,
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, specifically, X may be halogen or C₁₋₂₀ alkyl, respectively, and preferably, X may be chlorine or methyl, and
R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, in which R₁ to R₁₀ may be independently of each other connected to an adjacent group to form a substituted or unsubstituted and saturated or unsaturated C₄₋₂₀ ring, and specifically, R₁ to R₁₀ may be hydrogen, substituted or unsubstituted C₁₋₂₀ alkyl, substituted or unsubstituted C₁₋₂₀ alkenyl, or substituted or unsubstituted C₆₋₂₀ aryl, respectively.

In a specific example of the present invention, M₁ and M₂ may be different from each other and zirconium or hafnium, respectively, X may be halogen or C₁₋₂₀ alkyl, and R₁ to R₁₀ may be independently of each other hydrogen, substituted or unsubstituted C₁₋₂₀ alkyl, substituted or unsubstituted C₁₋₂₀ alkenyl, or substituted or unsubstituted C₆₋₂₀ aryl.

In a preferred specific example of the present invention, M₁ may be hafnium, M₂ may be zirconium, and X may be chlorine or methyl.

In a preferred specific example of the present invention, the first transition metal compound may be at least one of transition metal compounds represented by the following Chemical Formulae 1-1 and 1-2, and the second transition metal compound may be at least one of transition metal compounds represented by the following Chemical Formulae 2-1, 2-2, and 3-1:

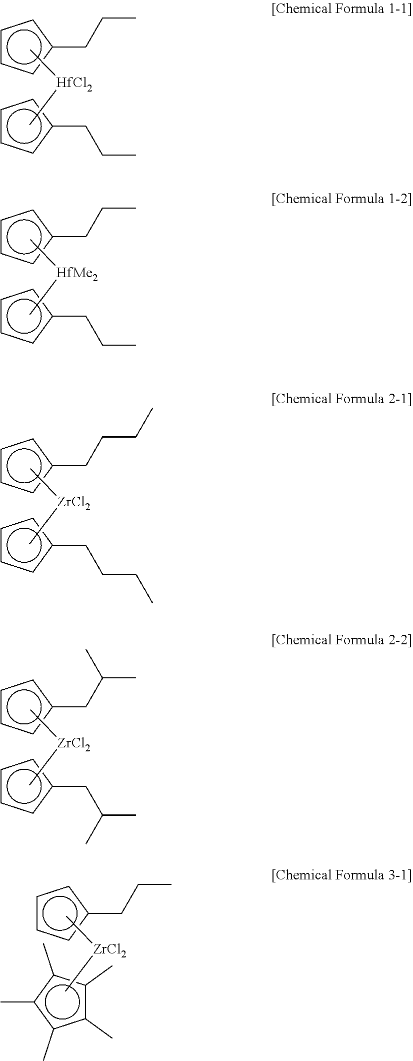

wherein Me is a methyl group.

In a specific example of the present invention, a mole ratio of the first transition metal compound to the second transition metal compound is in a range of 100:1 to 1:100. Preferably, a mole ratio of the first transition metal compound to the second transition metal compound is in a range of 50:1 to 1:50. Preferably, a mole ratio of the first transition metal compound to the second transition metal compound is in a range of 10:1 to 1:10.

In a specific example of the present invention, the catalyst may include at least one cocatalyst compound selected from the group consisting of a compound represented by the following Chemical Formula 4, a compound represented by the following Chemical Formula 5, and a compound represented by the following Chemical Formula 6:

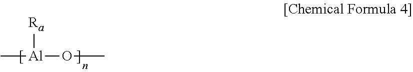

wherein n is an integer of 2 or more, Rₐ is a halogen atom, C₁₋₂₀ hydrocarbon, or C₁₋₂₀ hydrocarbon substituted with halogen, and specifically, Rₐ may be methyl, ethyl, n-butyl, or isobutyl,

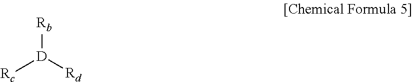

wherein D is aluminum (Al) or boron (B), and R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group, and specifically, when D is aluminum (Al) , R_{b}, R_{c}, and R_{d} may be independently of one another methyl or isobutyl, and when D is boron (B), R_{b}, R_{c}, and R_{d} may be pentafluorophenyl, respectively,

[L-H]⁺[Z (A)₄]⁻ or [L]⁺[Z (A)₄]⁻ [Chemical Formula 6]
wherein L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group, and specifically, [L-H]⁺ may be dimethylanilinium cation, [Z(A)₄]⁻ may be [B(C₆F₅)₄]⁻, and [L]⁺ may be [(C₆H₅)₃C]⁺.

Specifically, an example of the compound represented by Chemical Formula 4 includes methylaluminoxane, ethylaluminoxane, isobutylaluminoxane, butylaluminoxane, and the like, and is preferably methylaluminoxane, but is not limited thereto.

An example of the compound represented by Chemical Formula 5 includes trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, tributylboron, and the like, and is preferably trimethylaluminum, triethylaluminum, and triisobutylaluminum, but is not limited thereto.

An example of the compound represented by Chemical Formula 6 includes triethylammoniumtetraphenylboron, tributylammoniumtetraphenylboron, trimethylammoniumtetraphenylboron, tripropylammoniumtetraphenylboron, trimethylammoniumtetra(p-tolyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminum, tributylammoniumtetraphenylaluminum, trimethylammoniumtetraphenylaluminum, tripropylammoniumtetraphenylaluminum, trimethylammoniumtetra(p-tolyl)aluminum, tripropylammoniumtetra(p-tolyl)aluminum, triethylammoniumtetra(o,p-dimethylphenyl)aluminum, tributylammoniumtetra(p-trifluoromethylphenyl)aluminum, trimethylammoniumtetra(p-trifluoromethylphenyl)aluminum, tributylammoniumtetrapentafluorophenylaluminum, N,N-diethylaniliniumtetraphenylaluminum, N,N-diethylaniliniumtetrapentafluorophenylaluminum, diethylammoniumtetrapentatetraphenylaluminum, triphenylphosphoniumtetraphenylaluminum, trimethylphosphoniumtetraphenylaluminum, tripropylammoniumtetra(p-tolyl)boron, triethylammoniumtetra(o,p-dimethylphenyl)boron, tributylammoniumtetra(p-trifluoromethylphenyl)boron, triphenylcarboniumtetra(p-trifluoromethylphenyl)boron, triphenylcarboniumtetrapentafluorophenylboron, and the like.

In a specific example of the present invention, the catalyst may further include a carrier which supports a transition metal compound, a cocatalyst compound, or both of them. Specifically, the carrier may support both the transition metal compound and the cocatalyst compound.

Herein, the carrier may include a material containing a hydroxyl group on the surface, and preferably, may use a material having highly reactive hydroxyl group and siloxane group which is dried to remove moisture from the surface. For example, the carrier may include at least one selected from the group consisting of silica, alumina, and magnesia. Specifically, silica, silica-alumina, silica-magnesia, and the like which are dried at a high temperature may be used as the carrier, and these may usually contain oxide, carbonate, sulfate, and nitrate components such as Na₂O, K₂CO₃, BaSO₄, and Mg (NO₃)₂. In addition, these may include carbon, zeolite, magnesium chloride, and the like. However, the carrier is not limited thereto, and is not particularly limited as long as it may support a transition metal compound and a cocatalyst compound.

The carrier may have an average particle size of 10 to 250 μm, preferably 10 to 150 μm, and more preferably 20 to 100 μm.

The carrier may have a micropore volume of 0.1 to 10 cc/g, preferably 0.5 to 5 cc/g, and more preferably 1.0 to 3.0 cc/g.

The carrier may have a specific surface area of 1 to 1,000 m²/g, preferably 100 to 800 m²/g, and more preferably 200 to 600 m²/g.

In a preferred specific example of the present invention, the carrier may be silica. Herein, a drying temperature of the silica may be 200 to 900° C. The drying temperature may be 300 to 800° C., and more preferably 400 to 700° C. When the drying temperature is lower than 200° C., silica has too much moisture so that the moisture on the surface reacts with the cocatalyst compound, and when the drying temperature is higher than 900° C., the structure of the carrier may collapse.

A concentration of a hydroxyl group in dried silica may be 0.1 to 5 mmol/g, preferably 0.7 to 4 mmol/g, and more preferably 1.0 to 2 mmol/g. When the concentration of the hydroxyl group is less than 0.1 mmol/g, the supported amount of a first cocatalyst compound is lowered, and when the concentration is more than 5 mmol/g, the catalyst component becomes inactive.

The total amount of the transition metal compound supported on the carrier may be 0.001 to 1 mmol based on 1 g of the carrier. When a ratio between the transition metal compound and the carrier satisfies the above range, appropriate supported catalyst activity is shown, which is advantageous in terms of the activity maintenance of a catalyst and economic feasibility.

The total amount of the cocatalyst compound supported on the carrier may be 2 to 15 mmol based on 1 g of the carrier. When the ratio of the cocatalyst compound and the carrier satisfies the above range, it is advantageous in terms of the activity maintenance of a catalyst and economic feasibility.

The carrier may be one or two or more. For example, both the transition metal compound and the cocatalyst compound may be supported on one carrier, or each of the transition metal compound and the cocatalyst compound may be supported on two or more carriers. In addition, only one of the transition metal compound and the cocatalyst compound may be supported on the carrier.

As a method for supporting the transition metal compound and/or the cocatalyst compound which may be used in the catalyst for olefin polymerization, a physical adsorption method or a chemical adsorption method may be used.

For example, the physical adsorption method may be a method including bringing a solution in which a transition metal compound is dissolved into contact with a carrier and then drying, a method including bringing a solution in which a transition metal compound and a cocatalyst compound are dissolved into contact with a carrier and then drying, a method including bringing a solution in which a transition metal compound is dissolved into contact with a carrier and then drying to prepare a carrier on which the transition metal compound is supported, separately bringing a solution in which a cocatalyst compound is dissolved into contact with a carrier and then drying to prepare a carrier on which the cocatalyst compound is supported, and then mixing them, or the like.

The chemical adsorption method may be a method including first supporting a cocatalyst compound on the surface of a carrier and then supporting a transition metal compound on the cocatalyst compound, a method including binding a functional group (for example, a hydroxyl group (—OH) on the surface of silica, in the case of silica) on the surface of a carrier and a catalyst compound covalently.

In a specific example of the present invention, the olefin-based polymer may be a homopolymer of an olefin-based monomer or a copolymer of olefin-based monomer and comonomer. Preferably, the olefin-based polymer is a copolymer of an olefin-based monomer and an olefin-based comonomer.

Herein, the olefin-based monomer may be at least one selected from the group consisting of C₂₋₂₀ α-olefin, C₁₋₂₀ diolefin, C₃₋₂₀ cycloolefin, and C₃₋₂₀ cyclodiolefin.

For example, the olefin-based monomer may be ethylene, propylene, 1-butene, 1-pentene, 4-methyl-1-pentene, 1-hexene, 1-heptene, 1-octene, 1-decene, 1-undecene, 1-dodecene, 1-tetradecene, or 1-hexadecene, and the olefin-based polymer may be a homopolymer including only one olefin-based monomer exemplified above or a copolymer including two or more of the olefin-based monomers.

In an exemplary embodiment, the olefin-based polymer may be a copolymer of ethylene and C₃₋₂₀ α-olefin. Preferably, the olefin-based polymer may be a linear low-density polyethylene in which the olefin-based monomer is ethylene and the olefin-based comonomer is 1-hexene.

In this case, the content of ethylene is preferably 55 to 99.9 w t%, and more preferably 90 to 99.9 wt %. The content of the α-olefin-based comonomer is preferably 0.1 to 45 wt %, and more preferably 0.1 to 10 wt %.

### Method for Preparing Olefin-Based Polymer

According to an exemplary embodiment of the present invention, a method for preparing an olefin-based polymer including: polymerizing an olefin-based monomer in the presence of a hybrid catalyst including: at least one first transition metal compound represented by the following Chemical Formula 1; and at least one second transition metal compound selected from a compound represented by the following Chemical Formula 2 and a compound represented by the following Chemical Formula 3, thereby obtaining an olefin-based polymer, is provided:

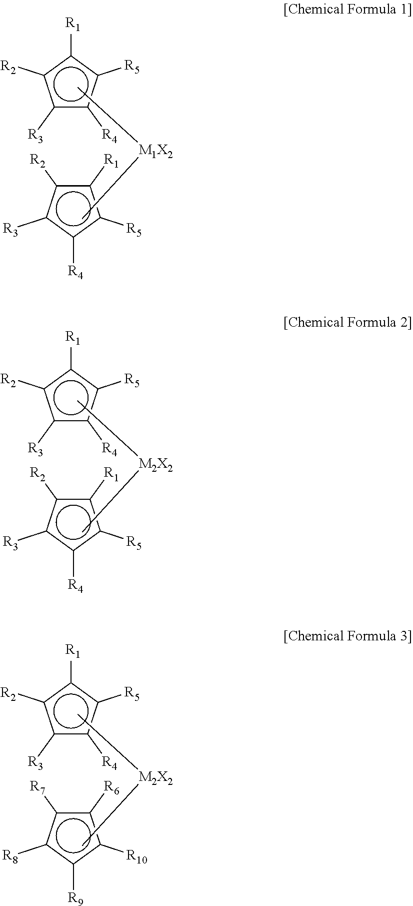

wherein M₁, M₂, X, and R₁ to R₁₀ are as defined above in the item of “olefin-based polymer”.

As described above, the olefin-based polymer prepared by the preparation method according to an exemplary embodiment of the present invention has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 5; and (4) satisfies the following Relation 1 in temperature rising elution fractionation (TREF) of a multimodal distribution:

C₆₅-C₄₅>15 (%) [Relation 1]
wherein C₄₅ is a weight % of a polymer eluted at 45° C., and C₆₅ is a weight % of a polymer eluted at 65° C.

In a specific example of the present invention, the olefin-based polymer may be polymerized by a polymerization reaction such as free radical, cationic, coordination, condensation, and addition polymerization, but is not limited thereto.

In an exemplary embodiment of the present invention, the olefin-based polymer may be prepared by a gas phase polymerization method, a solution polymerization method, a slurry polymerization method, or the like. Preferably, the polymerization of the olefin-based monomer may be performed by gas phase polymerization, and specifically, the polymerization of the olefin-based monomer may be performed in a gas phase fluidized bed reactor.

When the olefin-based polymer is prepared by a solution polymerization method or a slurry polymerization method, an example of the solvent to be used may include a C₅₋₁₂ aliphatic hydrocarbon solvent such as pentane, hexane, heptane, nonane, decane, and isomers thereof; an aromatic hydrocarbon solvent such as toluene and benzene; a hydrocarbon solvent substituted with a chlorine atom such as dichloromethane and chlorobenzene; and a mixture thereof, but is not limited thereto.

### Best Mode for Carrying Out the Invention

### EXAMPLES

Hereinafter, the present invention will be described in more detail through the following examples. However, the following examples are only illustrative of the present invention, and do not limit the scope of the present invention.

### Preparation Example

The transition metal compound of Chemical Formula 1-2 (dimethylbis (n-propylcyclopentadienyl) hafnium dichloride) and the transition metal compound of Chemical Formula 3-1 ((pentamethylcyclopentadienyl) (n-propylcyclopentadienyl) zirconium dichloride) were purchased from MCN, and used without further purification.

892 g of a 10% toluene solution of methylaluminoxane was added to 4.07 g of the transition metal compound of Chemical Formula 1-2 and 1.68 g of the transition metal compound of Chemical Formula 3-1, and the solution was stirred at room temperature for 1 hour. The resulting solution after the reaction was added to 200 g of silica (XPO-2402), 1.5 L of toluene was further added, and stirring was performed at 70° C. for 2 hours. The resulting catalyst after the support was washed with 500 mL of toluene, and was dried overnight at 60° C. under vacuum to obtain 280 g of a supported catalyst in a powder form.

### Examples 1 to 3

Ethylene/1-hexene copolymers were prepared, respectively, in the presence of the supported catalyst, which was obtained in the preparation example, using a gas phase fluidized bed reactor. The ethylene partial pressure of the reactor was maintained at about 15 kg/cm², and the polymerization temperature was maintained at 70 to 90° C.

The polymerization conditions of the examples are shown in the following Table 1.

TABLE 1

| | Example 1 | Example 2 | Example 3 |
|---|---|---|---|
| Polymerization temperature (° C.) | 74.8 | 80.4 | 83.6 |
| Catalyst injection amount (g/h) | 1.97 | 1.31 | 1.35 |
| Hydrogen injection amount (g/h) | 2.28 | 2.13 | 2.15 |
| 1-Hexene injection amount (kg/h) | 1.53 | 1.54 | 1.77 |
| Hydrogen/ethylene concentration (%) | 0.045 | 0.049 | 0.047 |
| ratio | | | |
| 1-Hexene/ethylene concentration (%) | 1.45 | 1.39 | 1.44 |
| ratio | | | |
| Production amount per hour (kg/h) | 6.91 | 6.22 | 6.52 |

### Comparative Examples 1 and 2

For comparison, linear low-density polyethylenes available from Hanwha Solutions, M181OHN (Comparative Example 1) and M2010EN (Comparative Example 2) were used.

### Test Example

The physical properties of the olefin-based polymer of the above examples were measured by the following methods and criteria. The results are shown in Table 2.

### (1) Density

Measured according to ASTM D 1505.

### (2) Melt Index and Melt Index Ratio (MFR)

The melt index was measured with a load of 21.6 kg and a load of 2.16 kg, respectively, at 190° C. in accordance with ASTM D1238, and the ratio (MI_{21.6}/MI_{2.16}) was calculated.

### (3) Polydispersity Index

A weight average molecular weight (Mw) and a number average molecular weight (Mn) were measured with gel permeation chromatography (GPC) and the polydispersity index was determined by the ratio.

### (4) TREF

A difference between a weight % value when the temperature was 65° C. and a weight % value when the temperature was 45° C. in a TREF graph showing an eluted cumulative weight percentage (sum wt %) depending on temperature using cross-fractionation chromatography (CFC) equipment was used.

TABLE 2

| | | Example | Example | Example | Comparative | Comparative |
|---|---|---|---|---|---|---|
| | Unit | 1 | 2 | 3 | Example 1 | Example 2 |
| MI_{2.16} | g/10 min | 1.11 | 0.87 | 0.99 | 1.02 | 1.04 |
| MI_{21.16} | g/10 min | 27.8 | 18.4 | 20.8 | 16.23 | 33.25 |
| MFR | — | 25 | 21.2 | 21.0 | 15.9 | 35.9 |
| Density | g/cm³ | 0.9210 | 0.9174 | 0.9197 | 0.9179 | 0.9186 |
| Polydispersity | — | 4.65 | 4.74 | 5.29 | 4.1 | 5.7 |
| index | | | | | | |
| C₆₅ − C₄₅ | % | 17.69 | 15.19 | 19.64 | 9.28 | 9.30 |

### INDUSTRIAL APPLICABILITY

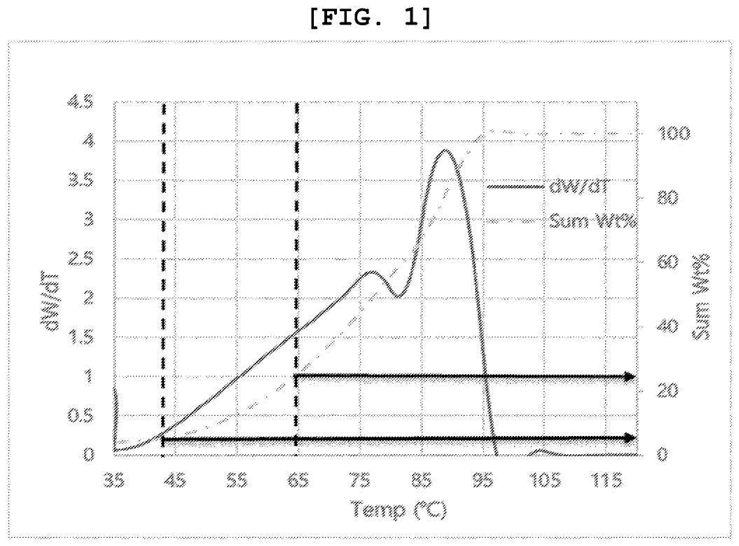

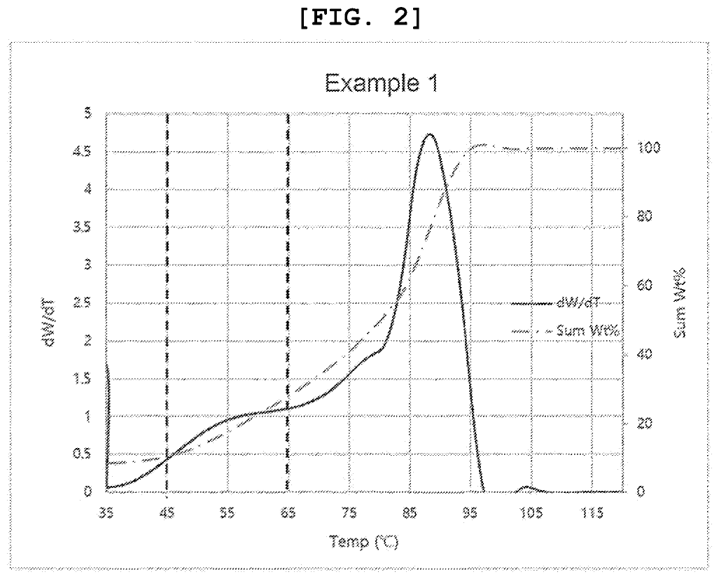

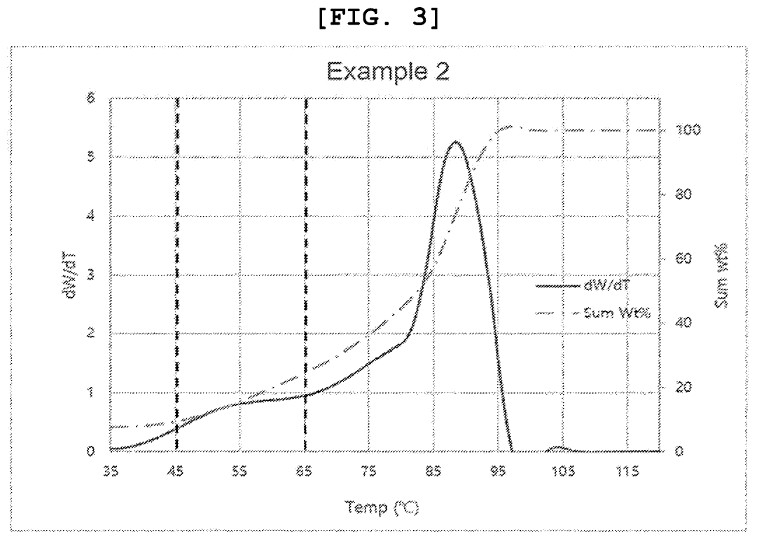

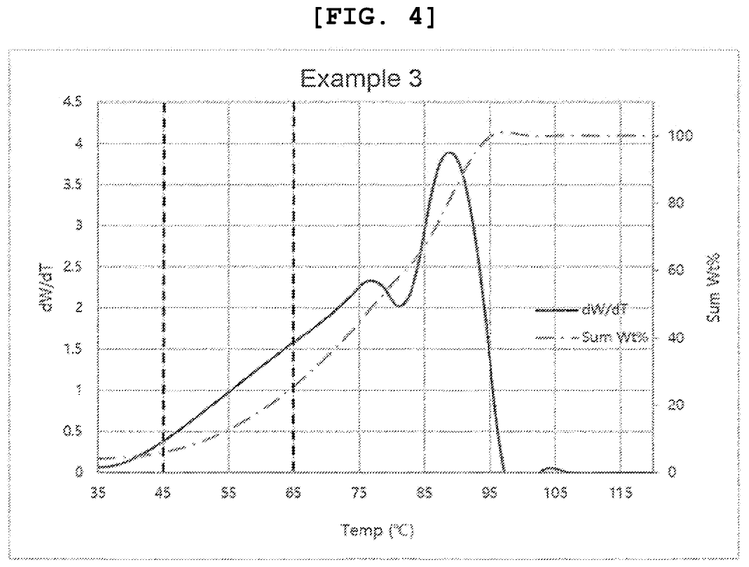

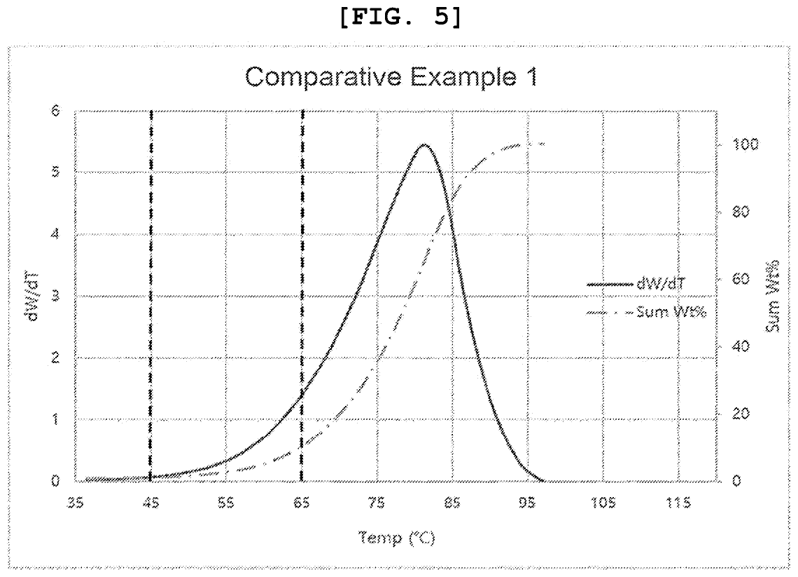

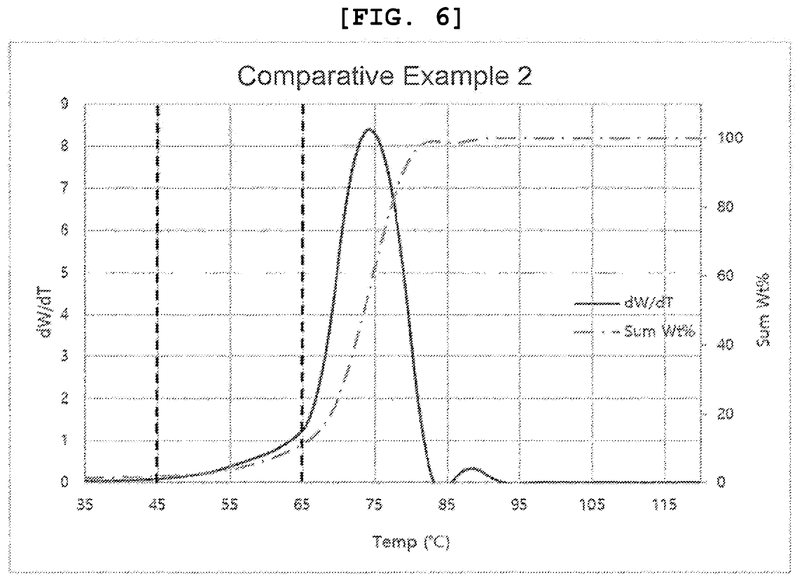

As confirmed from Table 2 and FIGS. 1 to 3, since the olefin-based polymer according to the specific example of the present invention has a high proportion of a highly branched copolymer derived from a comonomer, it has excellent heat-sealing property.

1. An olefin-based polymer which has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 6; and (4) satisfies the following Relation 1 in temperature rising elution fractionation (TREF) of a multimodal distribution:
C₆₅-C₄₅>15(%) [Relation 1]
wherein C₄₅ is a weight % of a polymer eluted at 45° C., and C₆₅ is a weight % of a polymer eluted at 65° C.

2. The olefin-based polymer of claim 1, wherein the olefin-based polymer has (1) the density of 0.915 to 0.940 g/cm³; (2) the melt index of 0.5 to 1.5 g/10 min as measured with a load of 2.16 kg at 190° C.; and (3) the polydispersity index of 4 to 6.

3. The olefin-based polymer of claim 1, wherein the olefin-based polymer is prepared by polymerizing an olefin-based monomer in the presence of a hybrid catalyst comprising: at least one first transition metal compound represented by the following Chemical Formula 1; and at least one second transition metal compound selected from a compound represented by the following Chemical Formula 2 and a compound represented by the following Chemical Formula 3: 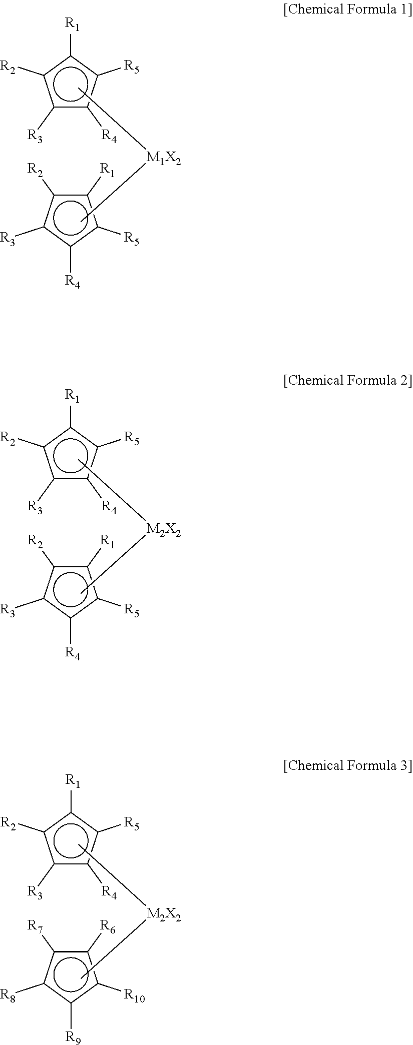
wherein M₁ and M₂ are different from each other and independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, and
R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of each other connected to an adjacent group to form a substituted or unsubstituted and saturated or unsaturated C₄₋₂₀ ring.

4. The olefin-based polymer of claim 3, wherein M₁ and M₂ are different from each other and zirconium or hafnium, respectively, X is halogen or C₁₋₂₀ alkyl, respectively, and R₁ to R₁₀ are independently of each other hydrogen, substituted or unsubstituted C₁₋₂₀ alkyl, substituted or unsubstituted C₁₋₂₀ alkenyl, or substituted or unsubstituted C₆₋₂₀ aryl.

5. The olefin-based polymer of claim 4, wherein M₁ is hafnium, M₂ is zirconium, and X is chlorine or methyl.

6. The olefin-based polymer of claim 3, wherein the first transition metal compound is at least one of transition metal compounds represented by the following Chemical Formulae 1-1 and 1-2, and the second transition metal compound is at least one of transition metal compounds represented by the following Chemical Formulae 2-1, 2-2, and 3-1: 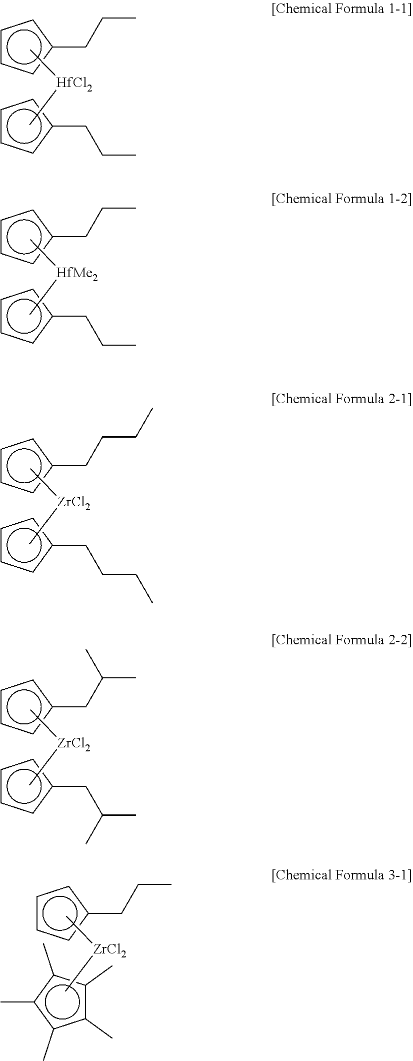
wherein Me is a methyl group.

7. The olefin-based polymer of claim 3, wherein a mole ratio of the first transition metal compound to the second transition metal compound is in a range of 100:1 to 1:100.

8. The olefin-based polymer of claim 3, wherein the catalyst comprises at least one cocatalyst compound selected from the group consisting of a compound represented by the following Chemical Formula 4, a compound represented by the following Chemical Formula 5, and a compound represented by the following Chemical Formula 6: 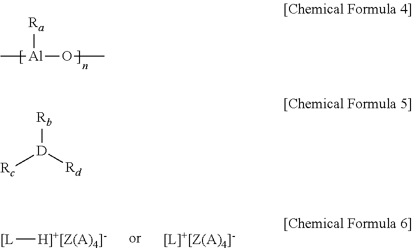
wherein n is an integer of 2 or more, Rₐ is a halogen atom, a C₁₋₂₀ hydrocarbon group, or a C₁₋₂₀ hydrocarbon group substituted with halogen,
D is aluminum (Al) or boron (B), R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

9. The olefin-based polymer of claim 8, wherein the catalyst further comprises a carrier which supports the transition metal compound, the cocatalyst compound, or both of them.

10. The olefin-based polymer of claim 9, wherein the carrier comprises at least one selected from the group consisting of silica, alumina, and magnesia.

11. The olefin-based polymer of claim 9, wherein a total amount of the hybrid transition metal compound supported on the carrier is 0.001 to 1 mmol based on 1 g of the carrier, and a total amount of the cocatalyst compound supported on the carrier is 2 to 15 mmol based on 1 g of the carrier.

12. The olefin-based polymer of claim 3, wherein the olefin-based polymer is a copolymer of an olefin-based monomer and an olefin-based comonomer.

13. The olefin-based polymer of claim 12, wherein the olefin-based monomer is ethylene, and the olefin-based comonomer is one or more selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene.

14. The olefin-based polymer of claim 13, wherein the olefin-based polymer is a linear low-density polyethylene in which the olefin-based monomer is ethylene and the olefin-based comonomer is 1-hexene.

15. A method for preparing an olefin-based polymer, the method comprising: polymerizing an olefin-based monomer in the presence of a hybrid catalyst comprising: at least one first transition metal compound represented by the following Chemical Formula 1; and at least one second transition metal compound selected from a compound represented by the following Chemical Formula 2 and a compound represented by the following Chemical Formula 3, thereby obtaining an olefin-based polymer, wherein the olefin-based polymer has (1) a density of 0.915 to 0.950 g/cm³; (2) a melt index (I_{2.16}) of 0.5 to 1.5 g/10 min as measured with a load of 2.16 kg at 190° C.; and (3) a polydispersity index (Mw/Mn) of 2 to 6; and (4) satisfies the following Relation 1 in temperature rising elution fractionation (TREF) of a multimodal distribution: 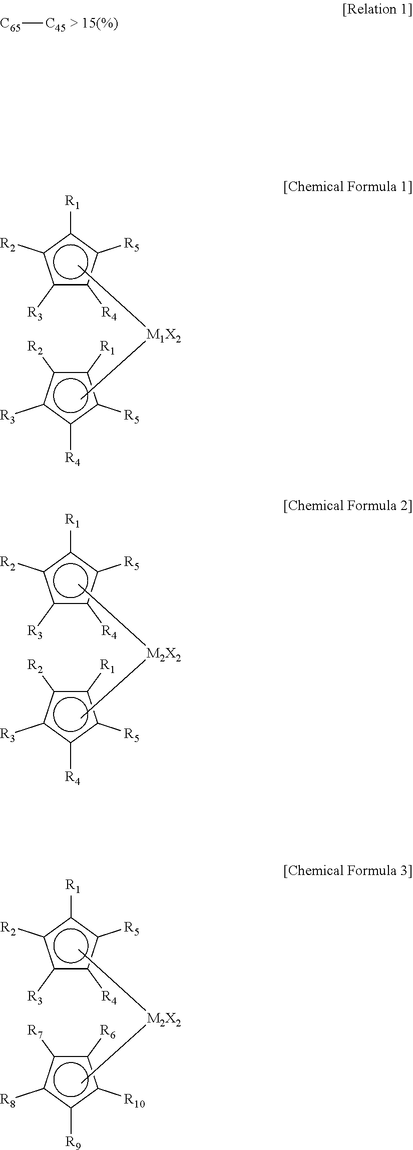
wherein C₄₅ is a weight % of a polymer eluted at 45° C.,
C₆₅ is a weight % of a polymer eluted at 65° C.,
M₁ and M₂ are different from each other and independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, and
R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of each other connected to an adjacent group to form a substituted or unsubstituted and saturated or unsaturated C₄₋₂₀ ring.

16. The method for preparing an olefin-based polymer of claim 15, wherein the polymerization of the olefin-based monomer is performed by gas phase polymerization.
